(19) United States
(12) Patent Application Publication
(10) Pub. No.: US 2017/0337880 A1
(43) Pub. Date: Nov. 23, 2017

(54) DISPLAY UNIT AND METHOD OF DRIVING DISPLAY UNIT, AND ELECTRONIC APPARATUS

(71) Applicant: Sony Corporation, Tokyo (JP)

(72) Inventors: Akihito Nishiike, Kanagawa (JP); Hidehiko Takanashi, Kanagawa (JP); Yuki Oishi, Kanagawa (JP)

(73) Assignee: Sony Corporation, Tokyo (JP)

(21) Appl. No.: 15/529,675

(22) PCT Filed: Nov. 5, 2015
(86) PCT No.: PCT/JP2015/081133

§ 371 Date: May 25, 2017

(30) Foreign Application Priority Data
Dec. 1, 2014 (JP) 2014-243163

(51) Int. Cl. G09G 3/34

(52) U.S. Cl. CPC G09G 3/344; G09G 2300/08; G09G 2320/066

(57) ABSTRACT

A display unit includes an electrophoretic display device in which an optical reflectance varies on a time-series basis depending on an applied voltage, and a drive circuit that performs voltage drive of the electrophoretic display device. The drive circuit applies a first voltage directed to display to the electrophoretic display device over a period of one or more frames, and applies, in the period of one or more frames, a second voltage that is different from the first voltage once or a plurality of times on or after a first point of time at which a derivative value of the optical reflectance reaches a maximum magnitude.

### TECHNICAL FIELD

The disclosure relates to a display unit using an electrophoretic display device and a method of driving such a display unit, and to an electronic apparatus that includes such a display unit.

### BACKGROUND ART

In recent years, along with the widespread use of mobile apparatuses such as a mobile phone, a personal digital assistant (PDA), or any other similar apparatus, the demand for a display unit that provides the high-definition image quality at low power consumption has been growing. Recently, in association with the emergence of a delivery business of electronic books, the display unit having the display quality level suitable for the reading application has been desired.

As such a display unit, various types of display units such as cholesteric liquid crystal, electrophoretic, electrochemical redox, twisting ball, and any other type are proposed, and a reflective display unit is favorable above all. This is because the reflective display unit carries out a bright display operation utilizing reflection (scattering) of outside light similarly to paper, thereby achieving the display quality level close to the paper.

Among the reflective display units, an electrophoretic display unit utilizing an electrophoretic phenomenon achieves low power consumption and fast response rate. For example, an electrophoretic device with use of a fibrous structure that enables high contrast and high-speed response is proposed (PTL 2). A drive method of such an electrophoretic display unit includes an active-matrix drive method using TFTs (Thin-Film Transistors), and any other devices, a segment method that puts a display body provided between a pair of segmented electrodes to perform a drive operation on each electrode basis, or any other method. When many small characters are to be displayed like electronic books, high-definition images are desired, and thus the active-matrix drive method has been widely used.

In driving the electrophoretic display unit, a voltage is applied in units of frames in the order of tens of milliseconds (frame period), and a single display switchover (write) operation is performed over a period of a plurality of frames (for example, tens of frames). Specifically, by applying each voltage of, for example, a positive-polarity voltage, a negative-polarity voltage, and 0 V in combination with one another, it is possible to represent white display (bright display), black display (dark display), or gray-scale display of the display unit.

For example, in making a switchover from the black display to the white display, a voltage for white display (white display voltage) continues to be applied over a period of a plurality of consecutive frames. On the contrary, in making a switchover from the white display to the black display, a voltage for black display (black display voltage) continues to be applied over a period of a plurality of consecutive frames, thereby achieving the desired display state (for example, see PTL 1).

### CITATION LIST

### Patent Literature

[PTL 1] Japanese Unexamined Patent Application Publication No. 2013-218342

[PTL 2] Japanese Unexamined Patent Application Publication No. 2012-22296

### SUMMARY OF THE INVENTION

However, the drive method admits of improvement in terms of the optical response property of the electrophoretic display device at the time of the white display in particular. It is desired to achieve the drive method that allows for improvement of the display quality level including the enhanced reflectance as well as high-speed and bright display.

Accordingly, it is desirable to provide a display unit and a method of driving such a display unit, and an electronic apparatus that allow for improvement of the display quality level.

A first display unit according to one embodiment of the disclosure includes: an electrophoretic display device in which an optical reflectance varies on a time-series basis depending on an applied voltage; and a drive circuit that performs voltage drive of the electrophoretic display device. The drive circuit applies a first voltage directed to display to the electrophoretic display device over a period of one or more frames, and applies a second voltage that is different from the first voltage during one or more vertical blanking periods in the period of one or more frames.

A second display unit according to one embodiment of the disclosure includes: an electrophoretic display device in which an optical reflectance varies on a time-series basis depending on an applied voltage; and a drive circuit that performs voltage drive of the electrophoretic display device. The drive circuit applies a first voltage directed to display to the electrophoretic display device over a period of one or more frames, and applies, in the period of one or more frames, a second voltage that is different from the first voltage on or after a first point of time at which a derivative value of the optical reflectance reaches a maximum magnitude.

A first drive method according to one embodiment of the disclosure includes: applying a first voltage to an electrophoretic display device over a period of one or more frames to vary an optical reflectance of the electrophoretic display device on a time-series basis, the first voltage being directed to display; and applying, upon varying the optical reflectance of the electrophoretic display device on the time-series basis, a second voltage that is different from the first voltage during one or more vertical blanking periods in the period of one or more frames.

A second drive method according to one embodiment of the disclosure includes: applying a first voltage to an electrophoretic display device over a period of one or more frames to vary an optical reflectance of the electrophoretic display device on a time-series basis, the first voltage being directed to display; and applying, upon varying the optical reflectance of the electrophoretic display device on the time-series basis and in the period of one or more frames, a second voltage that is different from the first voltage on or after a first point of time at which a derivative value of the optical reflectance reaches a maximum magnitude.

An electronic apparatus according to one embodiment of the disclosure includes the above-described first display unit according to the embodiment of the disclosure.

In the first display unit, the first drive method, and the electronic apparatus according to the respective embodiments of the disclosure, the optical reflectance of the electrophoretic display device is varied on a time-series basis by applying the first voltage to the electrophoretic display device over the period of one or more frames, resulting in transition to a display state (for example, white display) corresponding to the first voltage. The second voltage that is different from the first voltage is applied during one or more vertical blanking periods in the period of one or more frames. Consequently, in the electrophoretic display device, the optical response property is improved as compared with a case where the first voltage is only applied over the period of one or more frames, and the desired optical reflectance is achieved.

In the second display unit and the second drive method according to the respective embodiments of the disclosure, the optical reflectance of the electrophoretic display device is varied on a time-series basis by applying the first voltage to the electrophoretic display device over the period of one or more frames, resulting in transition to a display state (for example, white display) corresponding to the first voltage. The second voltage that is different from the first voltage is applied, in the period of one or more frames, on or after the first point of time at which the derivative value of the optical reflectance reaches the maximum magnitude. Consequently, in the electrophoretic display device, the optical response property is improved as compared with a case where the first voltage is only applied over the period of one or more frames, and the desired optical reflectance is achieved.

According to the first display unit, the first drive method, and the electronic apparatus of the respective embodiments of the disclosure, it is possible to perform display (for example, white display) corresponding to the first voltage in the electrophoretic display device by applying the first voltage to the electrophoretic display device over the period of one or more frames. The second voltage that is different from the first voltage is applied during one or more vertical blanking periods in the period of one or more frames, which makes it possible to achieve the desired optical reflectance in the electrophoretic display device. As a result, this allows the desired contrast ratio and brightness to be achieved. Further, by applying the second voltage during the vertical blanking period, it is possible to suppress instantaneous image flickering that may be caused by application of the second voltage. This allows for improvement of the display quality level.

According to the second display unit and the second drive method of the respective embodiments of the disclosure, it is possible to perform display (for example, white display) corresponding to the first voltage in the electrophoretic display device by applying the first voltage to the electrophoretic display device over the period of one or more frames. The second voltage that is different from the first voltage is applied, in the period of one or more frames, on or after the first point of time at which the derivative value of the optical reflectance reaches the maximum magnitude, which makes it possible to achieve the desired optical reflectance in the electrophoretic display device. As a result, this allows the desired contrast ratio and brightness to be achieved. This allows for improvement of the display quality level.

It is to be noted that the above descriptions are merely exemplified. The effects of the disclosure are not necessarily limitative, and effects of the disclosure may be other effects, or may further include other effects.

### BRIEF DESCRIPTION OF DRAWINGS

FIG. 1 is a block diagram illustrating a configuration of a display unit according to a first embodiment of the disclosure along with a configuration of a driver.

FIG. 2 is a cross-sectional view illustrating a key part configuration of a pixel section illustrated in FIG. 1.

FIG. 3 is a pattern diagram illustrating a configuration of a display body illustrated in FIG. 2.

FIG. 4 is a cross-sectional pattern diagram for describing a method of driving the display unit illustrated in FIG. 1.

FIG. 5A is a timing chart for describing the method of driving the display unit illustrated in FIG. 1.

FIG. 5B is a timing chart for describing an example of a gray-scale display operation.

FIG. 6 is a pattern diagram for describing transition of a display state relative to an applied voltage waveform.

FIG. 7A is a pattern diagram illustrating an example of an applied voltage waveform.

FIG. 7B is a pattern diagram illustrating an example of an applied voltage waveform.

FIG. 7C is a pattern diagram illustrating an example of an applied voltage waveform.

FIG. 7D is a pattern diagram illustrating an example of an applied voltage waveform.

FIG. 8A is a diagram illustrating optical response characteristics in a case where 0 V is applied in a final frame of a write period.

FIG. 8B is a diagram illustrating optical response characteristics in a case where 0 V is not applied in the final frame of the write period.

FIG. 9A is a pattern diagram for describing a partial display without the use of 0 V as an applied voltage.

FIG. 9B is a pattern diagram for describing a partial display (partial rewrite) with use of 0 V as an applied voltage.

FIG. 10A is a characteristic diagram illustrating an example of an applied voltage at the time of white display.

FIG. 10B is a characteristic diagram illustrating optical response characteristics (a change in the optical reflectance over time) as a function of the applied voltage illustrated in FIG. 10A.

FIG. 11A is a characteristic diagram illustrating an example of an applied voltage (including a reverse-polarity voltage) at the time of white display.

FIG. 11B is a characteristic diagram illustrating optical response characteristics as a function of the applied voltage illustrated in FIG. 11A.

FIG. 12 is a timing chart for describing an operation of applying a reverse-polarity voltage (during a vertical blanking period) in the display unit illustrated in FIG. 1.

FIG. 13A is a characteristic diagram illustrating an example of an applied voltage in a case where the drive operation illustrated in FIG. 12 is applied.

FIG. 13B is a characteristic diagram illustrating optical response characteristics as a function of the applied voltage illustrated in FIG. 13A.

FIG. 14A is a timing chart for describing a drive operation of a display unit according to a second embodiment of the disclosure.

FIG. 14B is a characteristic diagram illustrating an example of optical response characteristics when a reverse-polarity voltage is applied (duration of applying the voltage: 1 ms, 5 ms, and 10 ms) and when no reverse-polarity voltage is applied.

FIG. 15 is a pattern diagram for describing a timing sequence of applying a reverse-polarity voltage.

FIG. 16 is a cross-sectional view illustrating a key part configuration of a display unit according to a modification example 1.

FIG. 17 is a cross-sectional view illustrating a key part configuration of a display unit according to a modification example 2.

FIG. 18A is a perspective view illustrating a configuration of an electronic book according to an application example.

FIG. 18B is a perspective view illustrating a configuration of the electronic book according to the application example.

### DESCRIPTION OF EMBODIMENTS

Hereinafter, some embodiments of the disclosure are described in detail with reference to the drawings. It is to be noted that the description is given in the following order.

1. First Embodiment (an example of an electrophoretic display unit that applies a predetermined reverse-polarity voltage during a vertical blanking period)
2. Second Embodiment (an example of an electrophoretic display unit that applies a reverse-polarity voltage on or after a point of time at which a derivative value in optical response characteristics reaches its maximum level)
3. Modification Example 1 (an example of a drive method that uses no TFT devices)
4. Modification Example 2 (an example of a case where a reverse-polarity voltage is applied by varying a voltage on second electrode side)
5. Application Example (an example of an electronic book)

### 1. First Embodiment

### [Configuration]

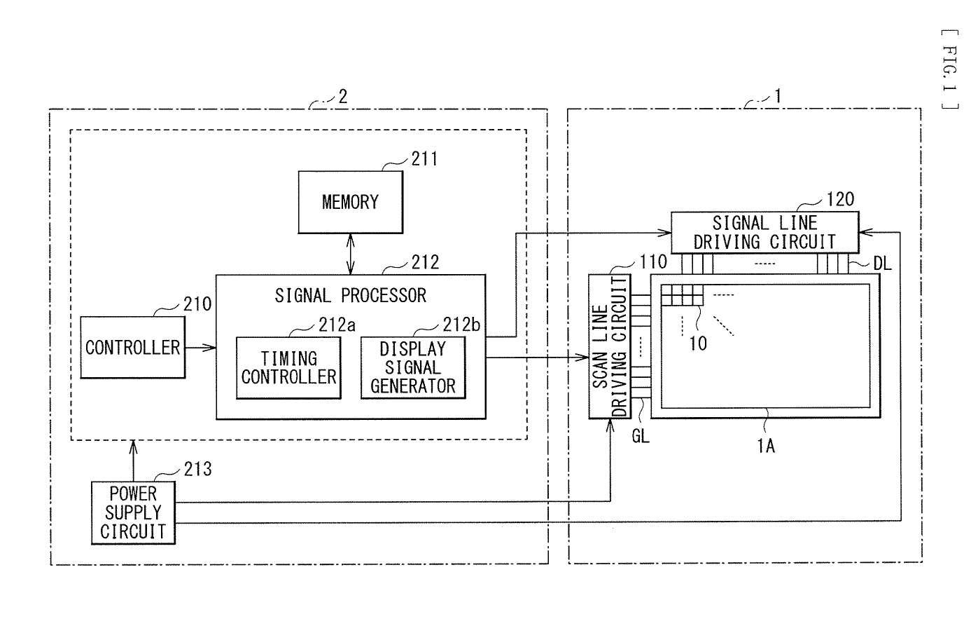

FIG. 1 illustrates a configuration of a display unit (display unit 1) according to a first embodiment of the disclosure along with a configuration of a driver thereof (driver 2). The display unit 1 may be an electrophoretic display unit that displays images utilizing an electrophoretic phenomenon, and may be a so-called electronic paper display.

The display unit 1 may have a plurality of pixels 10 (a pixel section 1A) that are display-driven with use of, for example, an active-matrix drive method using TFT devices. Each of the plurality of pixels 10 may include an electrophoretic display device (a display body 10A to be hereinafter described), and may display characters and images by changing optical reflectance of the display body 10A. The pixel section 1A may be coupled to a scan line drive circuit 110 and a signal line drive circuit 120. The pixel 10 may be provided at each of intersection points of a plurality of scan lines GL that are extended along a row direction from the scan line drive circuit 110 and a plurality of signal lines DL that are extended along a column direction from the signal line drive circuit 120.

The scan line drive circuit 110 may select the plurality of pixels 10 sequentially by applying scan signals sequentially to the plurality of scan lines GL in accordance with a control signal to be provided from the driver 2. In the present embodiment, the scan line drive circuit 110 may be configured to make it possible to provide outputs (apply ON voltages) simultaneously (in block) to TFT devices in all the pixels during a vertical blanking period. The signal line drive circuit 120 may generate an analog signal corresponding to a display-use signal in accordance with the control signal to be provided from the driver 2 to apply such a resulting analog signal to each of the signal lines DL. The display-use signal (signal voltage) that is applied to each of the signal lines DL by the signal line drive circuit 120 may be applied to the pixel 10 that is selected by the scan line drive circuit 110.

The driver 2 may be a drive section that performs signal generation, power delivery, or any other operation that are necessary for display-driving of the display unit 1. The driver 2 may include, for example, a controller 210, a memory 211, a signal processor 212, and a power supply circuit 213. The signal processor 212 may have, for example, a timing controller 212a and a display-use signal generator 212b. The timing controller 212a and the display-use signal generator 212b may generate various signals to be outputted to the scan lines GL and the signal lines DL, signals that control timing of application of those signals, or any other signals to be hereinafter described. It is to be noted that each of the driver 2, the scan line drive circuit 110, and the signal line drive circuit 120 corresponds to a specific example of a “drive circuit” in the disclosure.

### [Detailed Configuration Example of Display Unit 1]

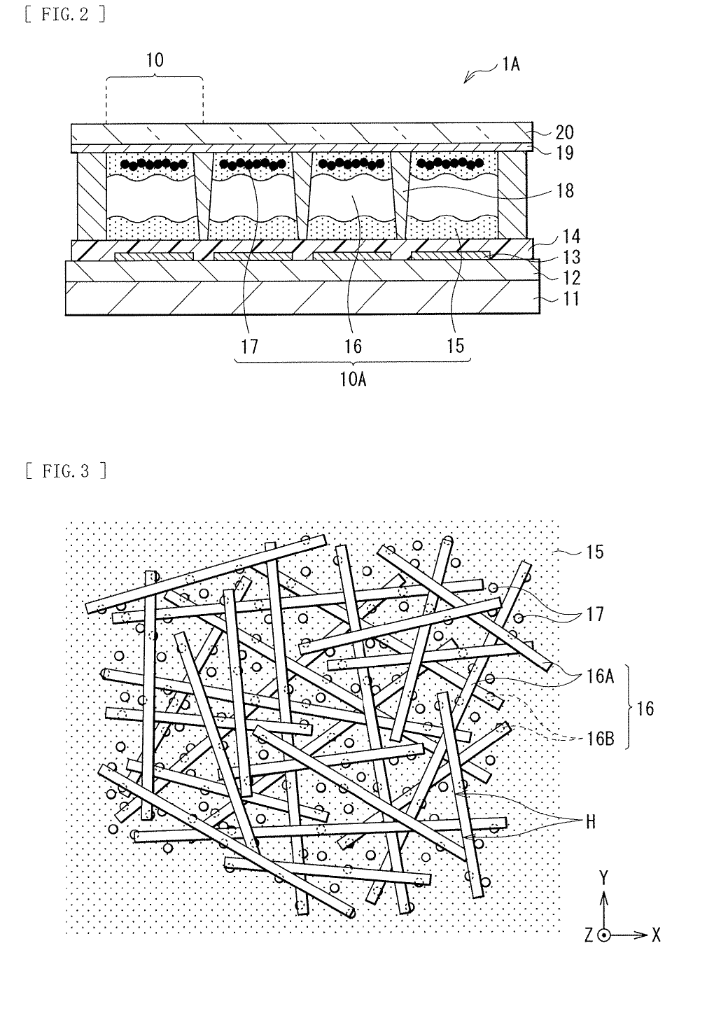

FIG. 2 illustrates a key part configuration of the pixel section 1A of the display unit 1. FIG. 3 illustrates a configuration of the display body 10A schematically. In the pixel section 1A, for example, a plurality of first electrodes (pixel electrodes) 13 may be provided with a TFT layer 12 in between on a first substrate 11. A sealing layer 14 may be provided to cover the TFT layer 12 and the first electrodes 13, and the display body 10A may be provided on the sealing layer 14. On the display body 10A, a second electrode (counter electrode) 19 and a second substrate 20 may be disposed in this order. The display body 10A may be configured to vary the optical reflectance (to generate contrast) depending on a voltage applied through the first electrodes 13 and the second electrode 19. A configuration of the display body 10A is not specifically limitative; however, the display body 10A may include a porous layer 16 and electrophoretic particles 17 in insulating liquid 15. The display body 10A may be separated for each of the pixels 10 by a partition 18. It is to be noted that, in this example, an electrophoretic device may be configured to be segmented by the partition 18; however, a configuration of the electrophoretic device is not limited thereto, and any other configuration (for example, a capsule-like configuration or a configuration without partitions) may be acceptable.

The first substrate 11 may include, for example, an inorganic material, a metallic material, or a plastic material. Examples of the inorganic material may include silicon (Si), silicon oxide (SiOx), silicon nitride (SiNx), and aluminum oxide (AlOx). The silicon oxide may contain, for example, glass and spin-on glass (SOG). Examples of the metallic material may include aluminum (Al), nickel (Ni), and stainless steel. Examples of the plastic material may include polycarbonate (PC), polyethylene terephthalate (PET), polyethylene naphthalate (PEN), and polyetheretherketone (PEEK).

The TFT layer 12 may be a layer formed with switching devices (TFT devices) that serve to select pixels. The TFT device may be an inorganic TFT that uses an inorganic semiconductor layer including, for example, amorphous silicon, polysilicon, or oxide as a channel layer, or may be alternatively an organic TFT using an organic semiconductor layer including pentacene or any other material. Further, a type of the TFT device is not specifically limitative, and may be an inversely-staggered structure (so-called bottom-gate type), or a staggered structure (so-called top-gate type), for example. Each of the TFT devices may be disposed for each of the pixels 10 to be electrically coupled to the first electrode 13.

The first electrode 13 may include one or more kinds of conductive materials such as gold (Au), silver (Ag), and copper (Cu), for example. The plurality of first electrode 13 may be disposed in a matrix pattern in the pixel section 1A.

The sealing layer 14 may include a resin material having the adhesive property.

The insulating liquid 15 may be a non-aqueous solvent such as an organic solvent, for example, and may be specifically a paraffin or isoparaffin, for example. The viscosity and refractive index of the insulating liquid 15 may be preferably as low as possible. This is because the mobility (response rate) of the electrophoretic particles 17 is improved, and an energy (power consumption) involving migration of the electrophoretic particles 17 is reduced accordingly. Further, this is also because the optical reflectance of the porous layer 16 is increased since a difference between the refractive index of the insulating liquid 15 and that of the porous layer 16 becomes greater.

It is to be noted that the insulating liquid 15 may contain a variety of materials as appropriate. For example, the insulating liquid 15 may contain coloring agent, charge-controlling agent, dispersion stabilizer, viscosity-preparing agent, surfactant agent, resin, or any other material.

The electrophoretic particles 17 may be one or two or more charged particles that are movable between the first electrode 13 and the second electrode 19, being dispersed in the insulating liquid 15. The electrophoretic particles 17 may be movable between the first electrode 13 and the second electrode 19 in the insulating liquid 15. The electrophoretic particles 17 may be particles (powders) including one or two kinds or more of any materials such as organic pigment, inorganic pigment, dye, carbon material, metallic material, metallic oxide, glass, polymer material (resin), and any other material, for example. It is to be noted that the electrophoretic particles 17 may be alternatively pulverized particles or capsule particles with resin solid content including the above-described particles. However, the materials corresponding to the carbon material, metallic material, metallic oxide, glass, or polymer material are to be excluded from the materials corresponding to the organic pigment, inorganic pigment, or dye. As the electrophoretic particles 17, one kind or a plurality of kinds of any of the above-described materials may be used.

The content (density) of the electrophoretic particles 17 in the insulating liquid 15 is not specifically limitative; however, the content (density) of the electrophoretic particles 17 may be, for example, within the range of 0.1% to 10% by weight. This is because the shielding (hiding) property and mobility of the electrophoretic particles 17 are assured. In this case, if the content is less than 0.1% by weight, there is a possibility that shielding of the porous layer 16 by the electrophoretic particles 17 will be more difficult. On the contrary, if the content is more than 10% by weight, migration of the electrophoretic particles 17 may become difficult due to deterioration in dispersibility of the electrophoretic particles 17, resulting in aggregation of the electrophoretic particles 17 in some cases.

Further, the electrophoretic particles 17 may also have any light reflective property (optical reflectance). The optical reflectance of the electrophoretic particles 17 is not specifically limitative; however, the optical reflectance of the electrophoretic particles 17 may be preferably set at least to ensure that the electrophoretic particles 17 shield the porous layer 16. This is because the contrast is generated by utilizing a difference between the optical reflectance of the electrophoretic particles 17 and that of the porous layer 16.

A specific constituent material of the electrophoretic particle 17 may be selected, for example, depending on the role assumed by the electrophoretic particle 17 to generate the contrast. Examples of a material to be used when bright display (white display) is performed with use of the electrophoretic particles 17 may include a metallic oxide such as titanium oxide, zinc oxide, zirconium oxide, barium titanate, and potassium titanate, and titanium oxide may be preferable above all. This is because titanium oxide may have superior electrochemical stability and dispersibility, and may achieve the high reflectance. On the other hand, examples of a material to be used when dark display (black display) is performed with use of the electrophoretic particles 17 may include a carbon material, metallic oxide, and any other material. Examples of the carbon material may include a carbon black and any other material. Examples of the metallic oxide may include copper-chromium oxide, copper-manganese oxide, copper-iron-manganese oxide, copper-chromium-manganese oxide, and copper-iron-chromium oxide. Above all, the carbon material may be preferable. This is because the carbon material assures superior chemical stability, mobility, and light absorption property.

A color of the electrophoretic particle 17 to be seen from the outside when the bright display is performed with use of the electrophoretic particles 17 is not specifically limitative as long as it is possible to generate the contrast; however, such a color of the electrophoretic particle 17 may be preferably white or a color close to white. On the other hand, a color of the electrophoretic particle 17 to be seen from the outside when the dark display is performed with use of the electrophoretic particles 17 is not specifically limitative as long as it is possible to generate the contrast; however, such a color of the electrophoretic particle 17 may be preferably black or a color close to black. This is because the contrast is enhanced in each case.

It is to be noted that preferably the electrophoretic particles 17 may be easy to be dispersed and charged in the insulating liquid 15 over a long period of time, and be hard to be absorbed to the porous layer 16. Therefore, to disperse the electrophoretic particles 17 by electrostatic repulsion, a dispersant (or charge-preparing agent) may be used, or the electrophoretic particles 17 may be subjected to surface treatment, or both of such methods may be combined.

The porous layer 16 may be, for example, a three-dimensional conformation structure (an irregular network structure like a non-woven cloth) that is formed by a fibrous structure 16A, as illustrated in FIG. 3. The porous layer 16 may have a plurality of clearance gaps (fine pores H) through which the electrophoretic particles 17 pass at locations where the fibrous structures 16A are not present.

The porous layer 16 may include one or two or more non-electrophoretic particles 16B, which are held by the fibrous structure 16A. In the porous layer 16 representing a three-dimensional conformation structure, the single fibrous structure 16A may intertangle in a random manner, or the plurality of fibrous structures 16A may gather together to overlap with one another in a random manner, or both of such configurations may be mixed. When the plurality of fibrous structures 16A are employed, each of the fibrous structures 16A may preferably hold one, two or more of the non-electrophoretic particles 16B. It is to be noted that FIG. 3 illustrates a case where the porous layer 16 is formed by the plurality of fibrous structures 16A.

The porous layer 16 as a three-dimensional conformation structure allows the optical reflectance of the porous layer 16 to be improved since outside light is subject to diffused reflection (multiple scattering) by virtue of an irregular conformation structure of the porous layer 16, and allows a thickness of the porous layer 16 to be thin for achieving the high optical reflectance. This leads to enhancement of the contrast, and reduction in energy necessary for moving the electrophoretic particles 17. Further, the porous layer 16 as a three-dimensional conformation structure allows the electrophoretic particles 17 to pass through the fine pores H more easily since an average pore diameter of the fine pore H increases and the number of fine pores H increases as well. This results in reduction in time necessary for migration of the electrophoretic particles 17, and also reduction in energy necessary for migration of the electrophoretic particles 17.

Inclusion of the non-electrophoretic particles 16B in the fibrous structure 16A allows the optical reflectance of the porous layer 16 to be improved since outside light is more easily subject to diffused reflection. This leads to enhancement of the contrast.

The fibrous structure 16A may be a fibrous substance having a sufficiently large length relative to a fiber diameter (diameter). The fibrous structure 16A may include, for example, one kind or two or more kinds of any of a polymer material or an inorganic material, or may include any material other than the above-describe materials. Examples of the polymer material may include nylon, polyacetate, polyamide, polyimide, polyethylene terephthalate, polyacrylonitrile, polyethylene oxide, polyvinyl carbazole, polyvinyl chloride, polyurethane, polystyrene, polyvinyl alcohol, polysulfone, polyvinyl pyrolidone, polyvinylidene fluoride, polyhexafluoropropylene, cellulose acetate, collagen, gelatin, chitosan, and copolymer of the above substances. Examples of the inorganic material may include titanium oxide, and any other substance. Above all, the polymer material may be preferable as a constituent material of the fibrous structure 16A. This is because such a material suppresses unintended decomposition reaction of the fibrous structure 16A by virtue of low reactivity (such as optical reactivity) (high chemical stability). It is to be noted that when the fibrous structure 16A includes a material having the high reactivity, a surface of the fibrous structure 16A may be preferably covered with any protective layer.

A shape (external appearance) of the fibrous structure 16A is not specifically limitative as long as the fibrous structure 16A takes a fibrous form having a sufficiently large length relative to a fiber diameter as described above. Specifically, the fibrous structure 16A may take a linear or kinky shape, or any shape that is folded on the way. Further, the fibrous structure 16A may not only extend in one direction, but also diverge in one direction or two or more directions on the way. A method of forming the fibrous structure 16A is not specifically limitative; however, it may be preferable to adopt, for example, a phase separation method, a phase reversal method, an electrostatic (electric field) spinning method, a melt-spinning method, a wet spinning method, a dry spinning method, a gel spinning method, a sol-gel method, or a spray coating method. This is because such methods facilitate formation of fibrous substances having a sufficiently large length relative to a fiber diameter with ease and stability.

An average fiber diameter of the fibrous structure 16A is not specifically limitative; however, the average fiber diameter of the fibrous structure 16A may be as small as possible. This is because light is subject to easier diffused reflection, and an average pore diameter of the fine pore H becomes larger. However, the average fiber diameter may be determined to ensure that the fibrous structure 16A holds the non-electrophoretic particles 16B. Therefore, it may be preferable that the average fiber diameter of the fibrous structure 16A be 10 μm or less. It is to be noted that a lower limit of the average fiber diameter is not specifically limitative; however, the lower limit may be 0.1 μm, and may be not more than 0.1 μm. The average fiber diameter may be measured through microscope observation with use of, for example, a scanning electron microscope (SEM) or any other instrument. It is to be noted that an average length of the fibrous structure 16A may be any length.

An average pore diameter of the fine pore H is not specifically limitative; however, the average pore diameter of the fine pore H may be preferably as large as possible. This is because such a diameter ensures that the electrophoretic particles 17 pass through the fine pores H more easily. Therefore, the average pore diameter of the fine pore H may be preferably within the range of 0.1 μm to 10 μm.

A thickness of the porous layer 16 is not specifically limitative; however, the thickness of the porous layer 16 may be, for example, within the range of 5 μm to 100 μm. This is because such a thickness ensures that the shielding property of the porous layer 16 is increased, and the electrophoretic particles 17 pass through the fine pores H more easily.

In particular, the fibrous structure 16A may be preferably a nanofiber. This is because the optical reflectance of the porous layer 16 is further improved since outside light is subject to diffused reflection by virtue of a complicated conformation structure, and the electrophoretic particles 17 pass through the fine pores H more easily since a proportion of a volume that the fine pore H accounts for in a unit volume of the porous layer 16 becomes greater. This leads to enhancement of the contrast, and reduction in energy necessary for migration of the electrophoretic particles 17. The nanofiber may be a fibrous material having a fiber diameter ranging from 0.001 μm to 0.1 μm and a length of one hundred or more times greater than the fiber diameter. The fibrous structure 16A that is the nanofiber may be preferably formed in the electrostatic spinning method with use of a polymer material. This is because such a method facilitates to form the fibrous structure 16A having a small fiber diameter with ease and stability.

It may be preferable that the fibrous structure 16A have the different optical reflectance property from that of the electrophoretic particles 17. Specifically, the optical reflectance of the fibrous structure 16A is not specifically limitative; however, the optical reflectance of the fibrous structure 16A may be preferably set to ensure that the porous layer 16 shields the electrophoretic particles 17 at least as a whole. As described above, this is because the contrast is generated by utilizing a difference of the optical reflectance of the electrophoretic particles 17 and that of the porous layer 16.

The non-electrophoretic particles 16B may be particles that are fixed to the fibrous structure 16A, and perform no electrophoretic migration. A constituent material of the non-electrophoretic particle 16B may be, for example, similar to the constituent material of the electrophoretic particle 17, and may be selected depending on a role assumed by the non-electrophoretic particle 16B as describe later. The non-electrophoretic particle 16B may have the different optical reflectance property from that of the electrophoretic particle 17. The optical reflectance of the non-electrophoretic particle 16B is not specifically limitative; however, the optical reflectance of the non-electrophoretic particle 16B may be preferably set to ensure that the porous layer 16 shields the electrophoretic particles 17 at least as a whole. As described above, this is because the contrast is generated by utilizing a difference of the optical reflectance of the electrophoretic particles 17 and that of the porous layer 16.

Here, a specific constituent material of the non-electrophoretic particle 16B may be selected depending on a role assumed by the non-electrophoretic particle 16B to generate the contrast, for example. Specifically, a material to be used when bright display is performed by the non-electrophoretic particles 16B may be similar to a material of the electrophoretic particle 17 to be selected when the bright display is performed. On the other hand, a material to be used when dark display is performed by the non-electrophoretic particles 16B may be similar to a material of the electrophoretic particle 17 to be selected when the dark display is performed. Above all, as a material to be selected when the bright display is performed by the non-electrophoretic particles 16B, a metallic oxide may be preferable, and titanium oxide may be more preferable. This is because the titanium oxide has superior electrochemical stability and fixable property, and achieves the high reflectance. As long as a constituent material of the non-electrophoretic particle 16B makes it possible to generate the contrast, such a material may be a similar kind to, or a different kind from a constituent material of the electrophoretic particle 17.

It is to be noted that a color seen when the bright display or the dark display is performed by the non-electrophoretic particle 16B may be similar to the color of the electrophoretic particle 17 seen as described above.

An example of procedures of forming the porous layer 16 is as follows. First, a constituent material (such as a polymer material) of the fibrous structure 16A may be dispersed or dissolved in an organic solvent or any other liquid to prepare a spinning solution. Next, the non-electrophoretic particles 16B may be added to the spinning solution, and thereafter the non-electrophoretic particles 16B may be dispersed in the spinning solution by performing sufficient stirring. Finally, fiber spinning may be carried out in the electrostatic spinning method with use of the spinning solution. This ensures that the non-electrophoretic particles 16B are held by the fibrous structure 16A, resulting in formation of the porous layer 16.

The second electrode 19 may include, for example, a transparent conductive film. Examples of a material for the transparent conductive film may include indium oxide-tin oxide (ITO), antimony oxide-tin oxide (ATO), fluorine-doped tin oxide (FTO), and aluminum-doped zinc oxide (AZO). Here, for example, the second electrode 19 may be provided on one side of the second substrate 20 as the electrode common to all of the pixels 10; however, the second electrode 19 may be segmented as with the first electrode 13 (the plurality of second electrodes 19 may be provided).

The second substrate 20 may include a material similar to a material to be used for the first substrate 11. However, since images are displayed on a top surface of the second substrate 20, a material having light-transmissive performance may be used for the second substrate 20. A color filter (not illustrated) may be provided in contact with one side of the second substrate 20, or on a layer above the second substrate 20.

### [Drive Method]

The display unit 1 according to the present embodiment may generate the contrast utilizing, for example, a difference between the optical reflectance of the electrophoretic particles 17 and that of the porous layer 16 as described above in a manner of performing voltage-drive of the pixel section 1A for each of the pixels 10, thereby making it possible to carry out white display, black display, or gray-scale display. Specifically, a voltage may be applied between the first electrode 13 and the second electrode 19 for each of the pixels 10, and the electrophoretic particles 17 may migrate between the first electrode 13 and the second electrode 19 depending on a magnitude of such an applied voltage and the polarity thereof. This makes it possible to vary the optical reflectance for each of the pixels 10 by utilizing, for example, either one or both of the light reflection property of the electrophoretic particles 17 and that of the porous layer 16.

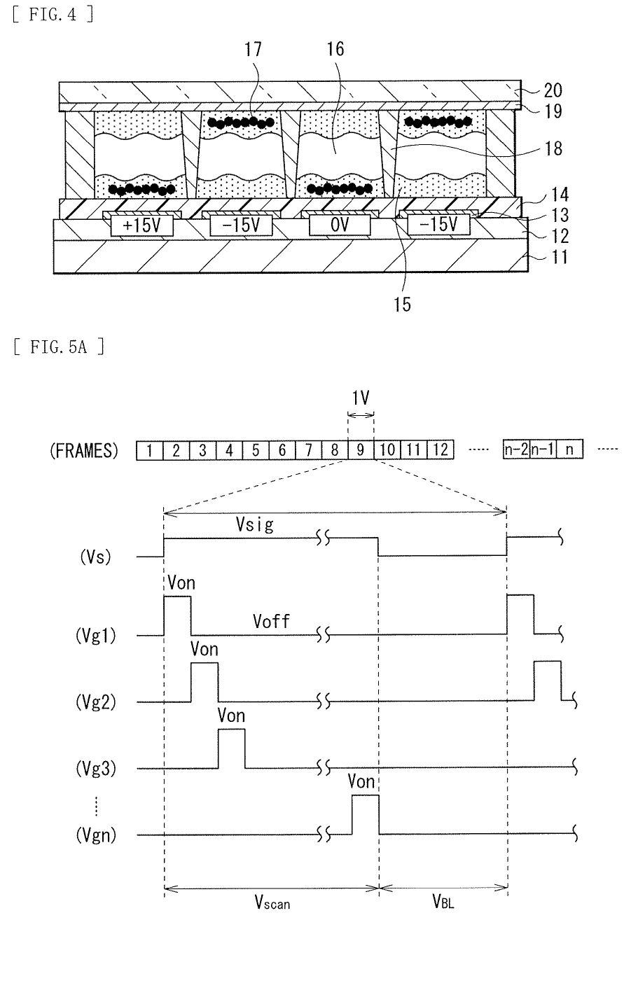

FIG. 4 schematically illustrates an example of a display operation of the display unit 1. As seen from the diagram, for example, a positive-polarity potential (+15 V as an example here) or a negative-polarity potential (−15 V as an example here) may be applied to each of the first electrodes 13, while holding the second electrode 19 at a common potential (for example, 0 V). Alternatively, 0 V may be applied to the first electrode 13. Consequently, a potential difference may be generated between the first electrode 13 and the second electrode 19 for each of the pixels 10, and a positive-polarity voltage, a negative-polarity voltage, or 0 V may be applied to the display body 10A. As a result, the electrophoretic particles 17 that are positively or negatively charged (negatively charged as an example here) may migrate to the first electrode 13 side or the second electrode 19 side.

In this example, in the pixel 10 in which +15 V is applied to the first electrode 13, the electrophoretic particles 17 may be shielded by the porous layer 16 by migration of the electrophoretic particles 17 to the first electrode 13 side. In other words, the optical reflectance of the porous layer 16 may become dominant, leading to a display state (to be hereinafter described as a white display state as an example) that corresponds to the optical reflectance of the porous layer 16. Meanwhile, in the pixel 10 in which −15 V is applied to the first electrode 13, the electrophoretic particles 17 may be exposed from the porous layer 16 by migration of the electrophoretic particles 17 to the second electrode 19 side. In other words, the optical reflectance of the electrophoretic particles 17 may become dominant, leading to a display state (to be hereinafter described as a black display state as an example) that corresponds to the optical reflectance of the electrophoretic particles 17. It is to be noted that a reason for application of 0 V will be described later.

However, the display unit 1 of an electrophoresis type may have a property that the optical reflectance varies on a time-series basis depending on the optical response property of the display body 10A at the time of transition from white display to black display, or from black display to white display. Therefore, it may be preferable to carry out voltage drive in consideration of such a time-series variation in the optical reflectance. In other words, to achieve a desired display state (gray-scale display), an applied voltage waveform (for example, a voltage application time period and timing) may be set by defining a period corresponding to a time span ranging from several frames to several tens of frames, for example (hereinafter referred to as a “write period”) as a unit period of image display or image rewrite. Further, it may be also effective to apply 0 V on a predetermined timing basis during the write period. In such a manner, the drive operation is carried out that ensures that a desired display state is achieved at the end of one write period by properly setting a voltage application time period and timing. Hereinafter, the description is provided on the drive operation in the case of transition (switchover) from black display to white display as an example of this drive operation.

### [Basic Display Drive Operation: Gray-Scale Display]

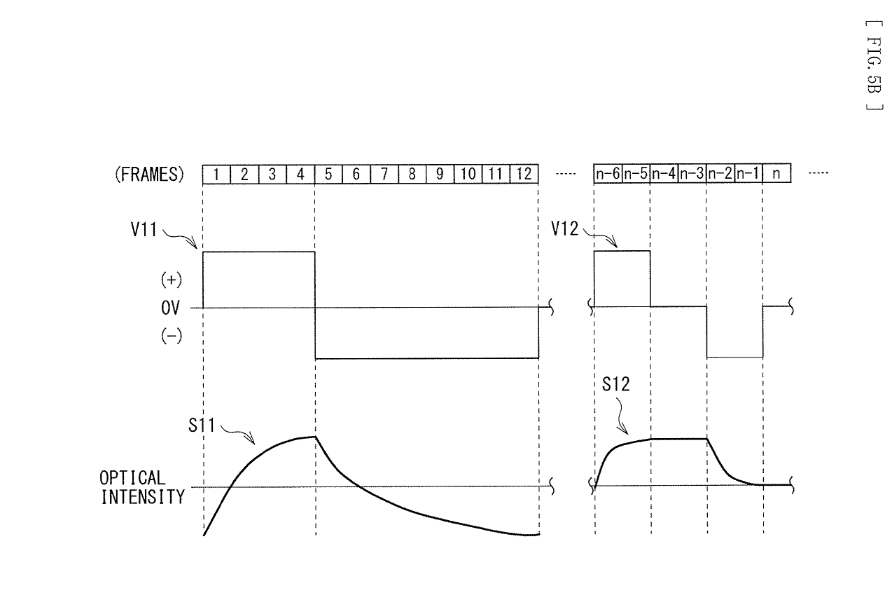

First, a basic display drive operation of the display unit 1 is described with reference to FIGS. 4, 5A, and 5B. It is to be noted that, in FIG. 5A, (Vs) denotes a waveform of a voltage to be applied to the signal line DL, and (Vg1), (Vg2), . . . , (Vgn) denote waveforms of voltages to be applied to the first to the n-th scan lines GL, respectively. Further, in the present specification, a single frame period (1V) is defined to include a scanning period Vscan (a time period necessary for scanning all the scan lines GL in a line-sequential manner) and a vertical blanking period V_{BL}. A frame frequency may be within the range of, for example, 40 Hz to 100 Hz, and a single frame period V may be within the range of, for example, 10 ms to 25 ms (milliseconds). Further, the vertical blanking period V_{BL} may be set to be within the range of, for example, 0.1 ms to 4 ms. It is to be noted that, in the present specification, a waveform observed in a case where an n-type TFT device is used is illustrated as an example of a waveform of a voltage to be applied to the scan line GL. When a p-type TFT device is used, a waveform of an on/off switching voltage is reversed to the illustrated waveform.

In such a manner, during a single frame period V (No. 9 frame in this example), a potential Vsig may be applied to the signal line DL, while an on potential Von may be applied to each of the scan lines GL in a line-sequential manner. As a result, in the selected pixel 10, a display-use voltage depending on the potential Vsig may be applied to the display body 10A through the TFT device. Specifically, the TFT device in the first-line pixel 10 may turn on in such a manner that the on potential Von is applied to the first scan line GL, for example. Thereafter, the potential Vsig of the signal line DL at that time may be selected to be applied to the first electrode 13. Consequently, a voltage depending on a potential difference between the first electrode 13 and the second electrode 19 may be applied to the display body 10A, and such an applied voltage may be held by a capacitor (not illustrated) that is formed in the pixel 10 even after the TFT device turns off (even after an off potential Voff is applied). Such an operation may be performed for each of the pixels 10, and the display body 10A may be driven for each of the pixels 10 by the voltage (equivalent to a potential difference between the first electrode 13 and the second electrode 19) that is held by the capacitor. In each of the pixels 10, the electrophoretic particles 17 may migrate between the electrodes as described above depending the applied voltage, resulting in variations in the optical reflectance. Such a voltage drive operation may be performed consecutively over a period of a plurality of frames.

As an example, FIG. 5B schematically illustrates a waveform of a voltage to be applied to the display body 10A, and a corresponding optical response waveform (a temporal variation in the optical reflectance). For example, as illustrated in a voltage waveform V11, when a drive operation is performed that applies positive-polarity voltages consecutively in frames 1 to 4, and thereafter applies negative-polarity voltages consecutively in frames 5 to 12, the optical response property of the display body 10A may exhibit a waveform S11, for example. In other words, the optical reflectance may increase (rise) gradually over a period from a start time point of the frame 1 to an end time point of the frame 4, resulting in transition from a black display state to a white display state. Further, the optical reflectance may decrease (fall) gradually over a period from a start time point of the frame 5 to an end time point of the frame 12, resulting in transition from a white display state to a black display state.

On the contrary, as illustrated in a voltage waveform V12, an applied voltage may be varied little by little. For example, positive-polarity voltages may be applied consecutively in frames (n−6) and (n−5), and thereafter 0 V may be applied in frames (n−4) and (n−3). Afterward, negative-polarity voltages may be applied consecutively in frames (n−2) and (n−1), and 0 V may be applied again in a final frame (n). When such a drive is performed, the optical response property of the display body 10A may exhibit a waveform S12, for example. In other words, the optical reflectance may increase gradually over a period from a start time point of the frame (n−6) to an end time point of the frame (n−5), resulting in transition from a gray-scale display state to a white display state, for example. Further, a display state (white display state) in the immediately previous frame may be kept over a period from a start time point of the frame (n−4) to an end time point of the frame (n−3). Thereafter, the optical reflectance may decrease gradually over a period from a start time point of the frame (n−2) to an end time point of the frame (n−1), resulting in transition from a white display state to a gray-scale display state. In the frame (n), a display state (gray-scale display state) in the immediately previous frame may be kept.

FIG. 6 illustrates an image of a gradation change in frames relative to an applied voltage as describe above. In such a manner, as a voltage waveform V13, for example, positive-polarity voltages may be applied consecutively during a period T1 corresponding to frames 1 to 9, and thereafter negative-polarity voltages may be applied consecutively during a period T2 corresponding to frames 10 and 11. Subsequently, 0 V may be applied during a period T3 corresponding to a frame 12, and thereafter a negative-polarity voltage may be applied during a period T4 corresponding to a frame 13. In this case, a gradation change as illustrated schematically may occur in the frames 1 to 13. This allows the gray-scale display to be achieved in a pulse width modulation (PWM) method on each frame basis.

As mentioned above, at the time of image display or image switchover in the pixel section 1A including the display body 10A (electrophoretic display device), a voltage waveform combining voltages such as a positive-polarity voltage, a negative-polarity voltage, and 0 V may be set in accordance with the optical response property of the display body 10A for each write period. In the example described here, it is possible to switch a display toward a white display state by applying the positive-polarity voltage, and to switch a display toward a black display state by applying the negative-polarity voltage.

### [Effects of Applied Voltage of 0 V]

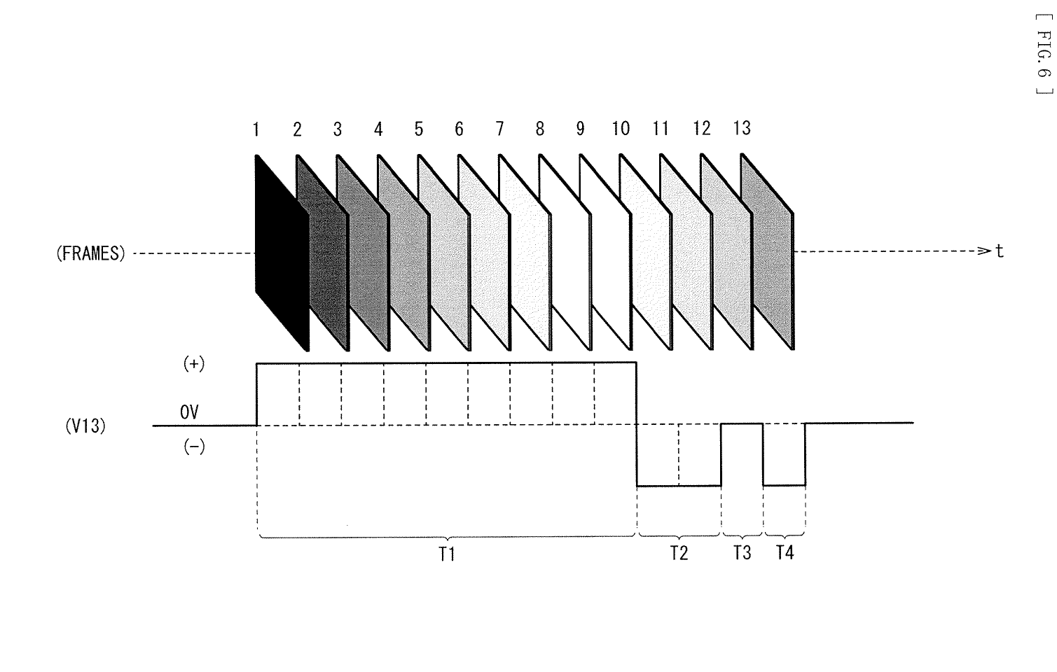

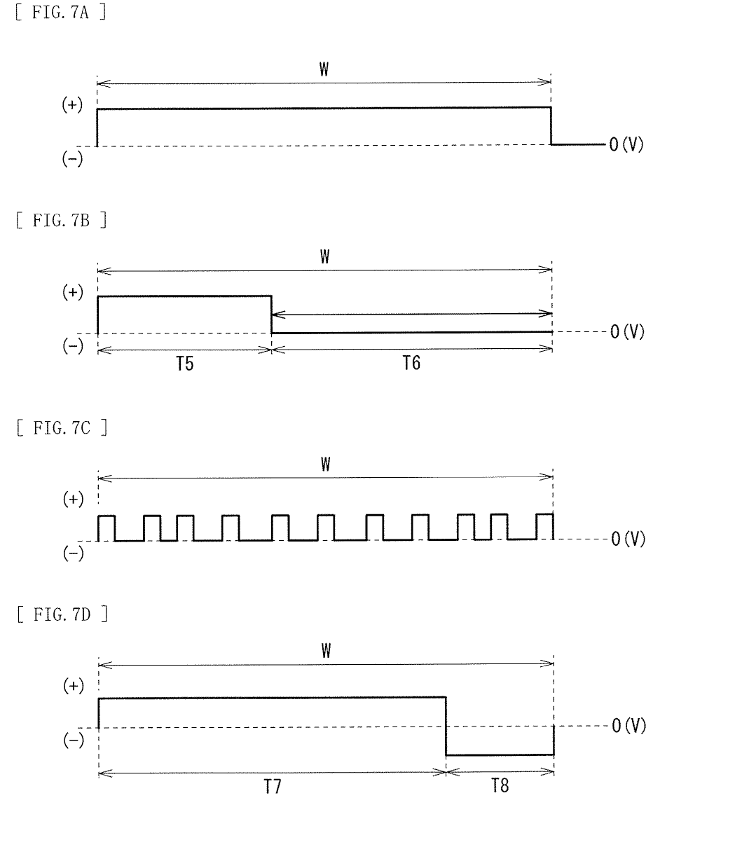

Further, by combining applied voltage of 0 V in addition to the positive-polarity voltage and the negative-polarity voltage, more elaborated gray-scale display is achievable. As an example, each of FIGS. 7A to 7D illustrates a voltage waveform at the time of switching from a black display state to a white display state or a low-gradation state. In an example in FIG. 7A, the positive-polarity voltage may be applied in full frame (for example, 500 ms) of a single write period W. Such an applied voltage makes it possible to make a switchover from a maximum black display state (full black display state) to a maximum white display state (full white display state). In an example in FIG. 7B, the positive-polarity voltage may be applied during a first half period T5 in the single write period W, and 0 V may be applied during a subsequent period T6 (for example, T5<T6). In an example in FIG. 7C, the positive-polarity voltages may be applied in intermittent frames in the single write period W, and 0 V may be applied in any other frames (the positive-polarity voltages and 0 V may be applied repeatedly by turns). In an example in FIG. 7D, the positive-polarity voltage may be applied during a first half period T7 in the single write period W, and 0 V may be applied during a subsequent period T8 (for example, T7>T8). In any of the examples illustrated in FIGS. 7B to 7D, it is possible to make a switchover from the full black state to the low-gradation state. As described above, there may be a plurality of patterns of applied voltage waveforms for the gray-scale display, and the patterns are not limited to those illustrated.

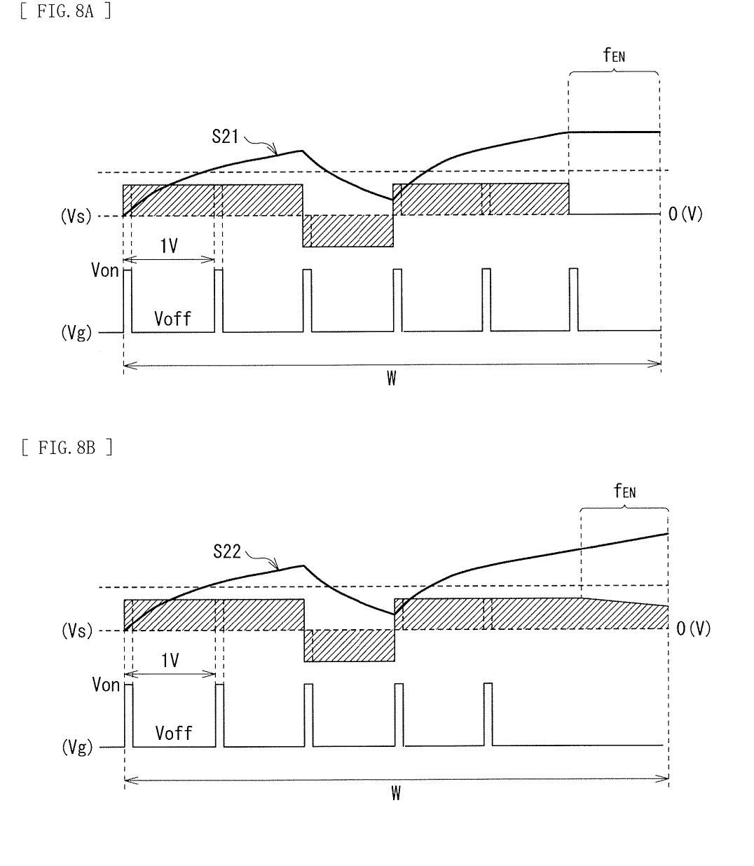

Further, the following advantages are obtained by applying 0 V in the final frame of the write period. FIG. 8A illustrates voltage waveforms Vg and Vs observed when 0 V is applied in a final frame f_{EN} of the write period W, and a waveform S21 of the optical response property of the display body 10A relative to the applied voltage. In addition, as a comparative example, FIG. 8B illustrates the voltage waveforms Vg and Vs observed when 0 V is not applied in the final frame f_{EN} of the write period W, and a waveform S22 of the optical response property of the display body 10A relative to the applied voltage. It is to be noted that charged voltages held by the capacitor (Cs) of the pixel 10 are denoted with oblique lines in FIGS. 8A and 8B. In the comparative example illustrated in FIG. 8B, a voltage that has been applied in a frame immediately prior to the final frame f_{EN} may remain in the capacitor Cs. Therefore, a voltage may continue to be applied to the display body 10A, leading to a continued increase in the optical reflectance. This may make it difficult to achieve the desired optical reflectance. On the contrary, when 0 V is applied in the final frame f_{EN} as illustrated in FIG. 8A, the capacitor Cs is discharged in the final frame f_{EN}, and the optical reflectance at an end time point of the frame immediately prior to the final frame f_{EN} is maintained. This makes it easy to achieve the desired optical reflectance. That is, the gradation control on the basis of applied voltage×time is facilitated. As described above, in the voltage drive with use of the TFT device, it may be preferable to apply 0 V in the final frame of the write period W.

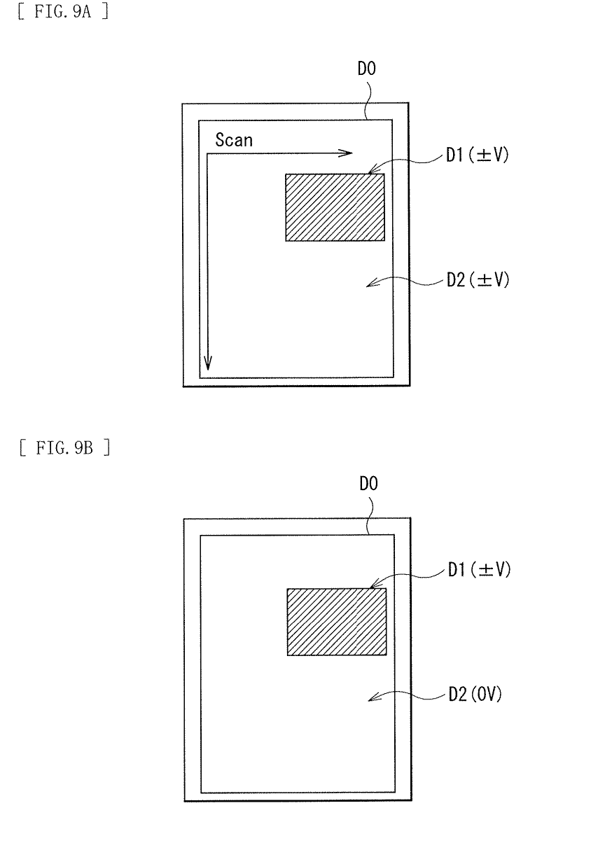

Further, also in the following case, the applied voltage of 0 V is useful. Each of FIGS. 9A and 9B schematically illustrates an operation of rewriting a display image at a portion of a display screen (partial rewrite operation). An example in FIG. 9A is an example where 0 V is not used. In this example, even when an image at only a partial region D1 of a display screen D0 is to be changed, scanning may be performed on a full screen including a region D2 where no image is to be changed, and a positive-polarity voltage or a negative-polarity voltage may be applied to all of the pixels 10. On the contrary, in an example illustrated in FIG. 9B, the positive-polarity voltage or the negative-polarity voltage is applied in only the region D1 of the display screen D0, and 0 V is applied to the region D2. Such a use of 0 V during the partial rewrite operation leads to improvement of the display quality. Therefore, the display body 10A may preferably have characteristics (memory performance) ensuring that the optical response property is hard to vary even during application of 0 V.

### [Drive Operation for Improving Optical Reflectance]

As described above, the display unit 1 may carry out the white display, black display, or gray-scale display by utilizing a method of varying the optical reflectance for each of the pixels 10 depending on the applied voltage. In such a display unit 1 with use of the electrophoretic display device, it may be preferable that the optical reflectance at the time of the white display be high in particular to enhance the visibility.

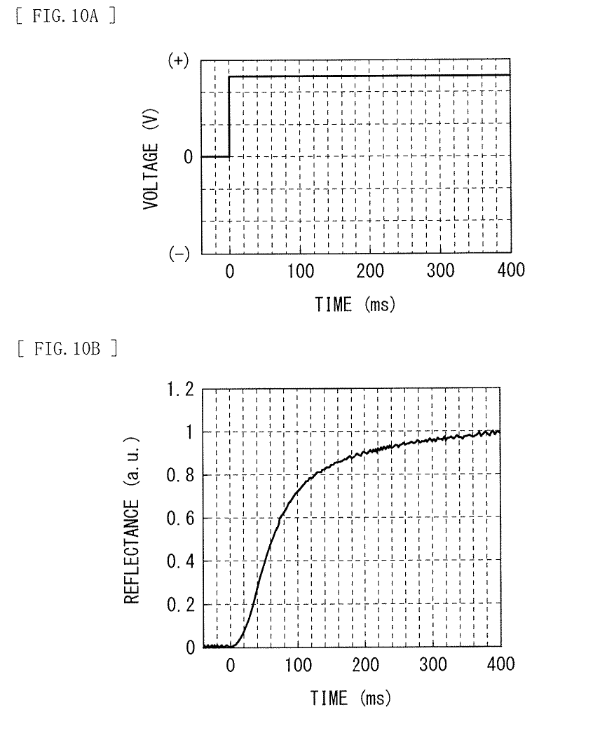

Here, FIG. 10A illustrates an example of a waveform of a voltage to be applied at the time of switchover from the black display to the white display. Further, FIG. 10B illustrates the optical response property of the display body 10A that is observed when the voltage of the waveform illustrated in FIG. 10A is applied. As mentioned previously, in the optical response property of the display body 10A, the optical reflectance may rise gradually (on time-series basis) over a period of a plurality of frames. For example, as illustrated in FIGS. 10A and 10B, the desired reflectance (1 in this example) may be reached by continuing to apply a positive-polarity voltage during a period of 400 ms.

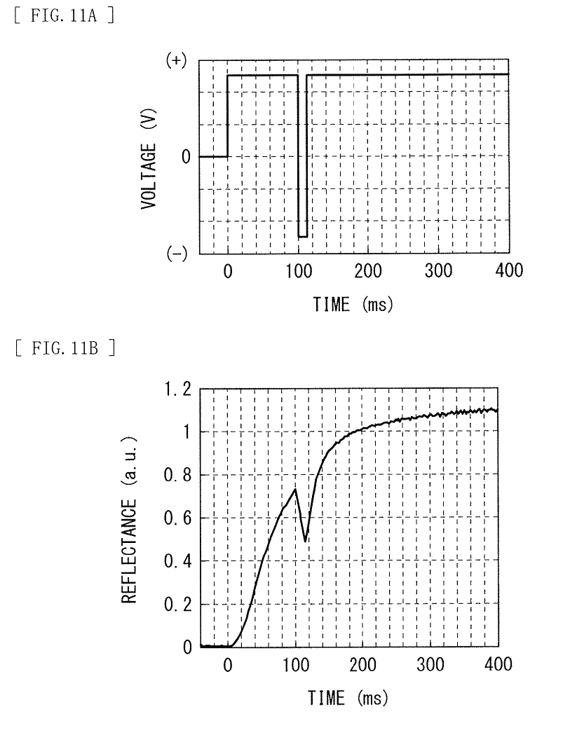

In the middle of such a write period, a reverse-polarity voltage opposite to a voltage (a positive-polarity voltage in this example) for transition to a white display state or 0 V (a negative-polarity voltage in this example) may be applied, thereby allowing for enhancement of the optical reflectance at the time of the white display consequently. Each of FIGS. 11A and 11B illustrates an example thereof. FIG. 11A is an example of a waveform of a voltage to be applied at the time of switchover from the black display to the white display. In this example, during a period equivalent to one frame after the elapsed time of about 100 ms from start of application of the positive-polarity voltage, the negative-polarity voltage may be applied as the reverse-polarity voltage. After the reverse-polarity voltage is applied, the positive-polarity voltage may be continued to be applied again. FIG. 11B illustrates the optical response property of the display body 10A in accordance with the voltage waveform illustrated in FIG. 11A. As seen from the diagram, when the reverse-polarity voltage is applied in the middle of the write period, the optical reflectance may drop instantaneously, but may rise again afterward. A rate of rise in the optical reflectance at this time may become greater than a case where the positive-polarity voltage is only applied (FIG. 10B). As a result, the desired reflectance is achieved easily in shorter timing (after the elapsed time of about 200 ms in this example) as compared with a case where the positive-polarity voltage is only applied. In such a manner, it is possible to improve the optical reflectance by applying the reverse-polarity voltage at the time of changeover to the white display or the black display.

Although the optical reflectance may be enhanced as a result of applying the reverse-polarity voltage in the middle of the white display, a display state may shift to the black display on a temporary basis in the middle of the white display (the optical reflectance may drop instantaneously), and thereafter may return to the white display due to the application of the reverse-polarity voltage over a period of one frame. Such a phenomenon may be visible as flickering of images (flickering may occur in images), which may in turn lead to deterioration in the display quality.

### [Application of Reverse-Polarity Voltage During Vertical Blanking Period]

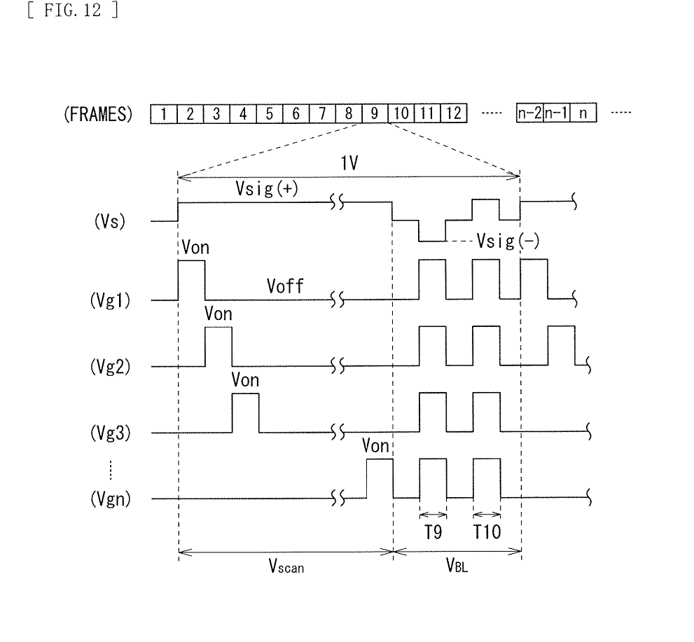

Accordingly, in the present embodiment, the drive operation of applying the reverse-polarity voltage as described above may be performed during the vertical blanking period V_{BL}. FIG. 12 is a timing chart for describing the drive operation in the present embodiment. In FIG. 12, (Vs) denotes a waveform of a voltage to be applied to the signal line DL, and (Vg1), (Vg2), . . . , (Vgn) denote waveforms of voltages to be applied to the first to the n-th scan lines GL, respectively. In this example, the frame frequency may be also within the range of, for example, 40 Hz to 100 Hz, and a single frame period V may be within the range of, for example, 10 ms to 25 ms (milliseconds). Further, the vertical blanking period V_{BL} may be set to be within the range of, for example, 0.1 ms to 4 ms.

Specifically, a voltage (second voltage) that is different from a display-use voltage (first voltage) to be applied over a period V including one or more frames is applied during the vertical blanking period V_{BL}. For example, when a positive-polarity voltage is applied during a scan period Vscan immediately prior to the vertical blanking period V_{BL}, a reverse-polarity voltage thereof (a negative-polarity voltage) or 0 V may be applied during the vertical blanking period V_{BL}. In concrete terms, for the signal lines DL, a positive-polarity potential Vsig(+) may be applied during the scan period Vscan, and thereafter a negative-polarity potential Vsig(−) may be applied during the vertical blanking period V_{BL}. At this time, the potential Vsig(−) may be outputted to all of the signal lines DL by the signal line drive circuit 120. Meanwhile, for the scan lines DL, an ON potential may be applied to the TFT devices in all of the pixels 10 at the same time (during a period T9) by the scan line drive circuit 110. This may control all the TFT devices in the pixel section 1A to be turned on during the period T9. In other words, all of the pixels 10 may be selected, and the negative-polarity potential Vsig(−) may be applied to the first electrode 13 in each of the pixels 10. As a result, the negative-polarity voltage may be applied to each of the pixels 10 during the period T9 in which the TFT device remains in a turn-on state.

The timing of applying a reverse-polarity voltage (a negative-polarity voltage in this example) is not specifically limited within the single vertical blanking period V_{BL}. Further, the reverse-polarity voltage may be applied only once or a plurality of times within the single vertical blanking period V_{BL}. In addition, an example in the FIG. 12 illustrates only one frame period V; however, there may be the plurality of vertical blanking periods V_{BL} during the overall write period. The reverse-polarity voltage may be applied only once or a plurality of times during each of the plurality of vertical blanking periods V_{BL}. Alternatively, the reverse-polarity voltage may be applied only once or a plurality of times during the selective vertical blanking period V_{BL} among the plurality of vertical blanking periods V_{BL}. However, as described in a second embodiment later, the reverse-polarity voltage or 0 V may be preferably applied on or after a point of time at which a derivative value of the optical reflectance in the optical response property reaches a peak magnitude thereof. It is because this allows the optical reflectance to be improved more efficiently.

The amount of time taken to apply the reverse-polarity voltage may be preferably within the range of 0.1 ms to 4.0 ms, for example. The amount of time may be set at not less than 4.0 ms; however, this may result in an increase in length of the frame period V, and spending more time on the display rewrite operation. It is to be noted that the description is here provided on a case where a negative-polarity voltage is applied as a voltage that is different from a positive-polarity voltage for display use; however, 0 V may be applied instead of the negative-polarity voltage. Further, when a voltage to be used for switchover to the white display is a negative-polarity voltage in consideration of the optical property of the display body 10A, it goes without saying that a positive-polarity voltage may be applied as a reverse-polarity voltage thereof.

During the vertical blanking period V_{BL}, it may be preferable to apply a voltage of the same polarity or potential as a positive-polarity voltage that has been applied during the scan period Vscan after the negative-polarity voltage is applied as described above. One reason is to prevent the negative-polarity voltage or 0 V from being continued to be hold on the capacitor until the next scan period. Specifically, during a period T10, for example, a positive-polarity potential Vsig(+) may be applied to all of the signal lines DL by the signal line drive circuit 120. Meanwhile, for the scan lines DL, the ON potential may be applied to the TFT devices in all of the pixels 10 at the same time (during the period T10) by the scan line drive circuit 110. This may control all the TFT devices in the pixel section 1A to be turned on during the period T10. In other words, during the period T10, all of the pixels 10 may be selected, and the positive-polarity voltage may be applied to each of the pixels 10.

It is to be noted that when the ON voltage Von is applied to the scan lines GL a plurality of times during the vertical blanking period V_{BL}, a time interval (a time length when a potential Voff is applied between the periods T9 and T10) may be fixed or variable for each frame.

Upon completion of the vertical blanking period V_{BL}, the pixels 10 may be selected in a line-sequential manner during the scan period Vscan of the next frame, and a display-use voltage (for example, a positive-polarity voltage) may be applied to the display body 10A again. In such a manner, the voltage drive may be performed over a period of the plurality of frames to display a single image (switch the image) during a single write period.

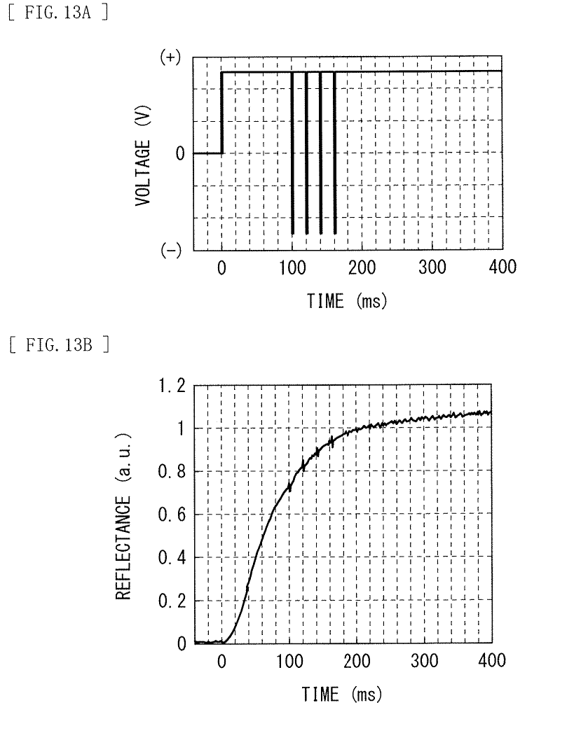

Each of FIGS. 13A and 13B illustrates an example of a voltage waveform when a reverse-polarity voltage is applied during the vertical blanking period V_{BL}, and the corresponding optical response property. FIG. 13A is an example of a waveform of a voltage to be applied for switchover to the white display over a period of the plurality of frames. In this example, a negative-polarity voltage may be applied as a reverse-polarity voltage after the elapsed time of about 100 ms from a point of time of starting to apply a positive-polarity voltage (during the vertical blanking period V_{BL} of the fifth frame). Further, the negative-polarity voltage may be applied during each of the vertical blanking periods V_{BL} over a period of subsequent three frames in total. That is, the negative-polarity voltage may be applied during each of the total of four vertical blanking periods V_{BL} within the write period. After the negative-polarity voltage is applied four times in total, the positive-polarity voltage may continue to be applied again.

FIG. 13B illustrates the optical response property of the display body 10A in response to the applied voltage waveform illustrated in FIG. 13A. As seen from the diagram, by applying the reverse-polarity voltage in the middle of application of the positive-polarity voltage, the optical reflectance may drop a little instantaneously (in the order of several milliseconds); however, the optical reflectance may rise as the whole response property as compared with a case where only the positive-polarity voltage continues to be applied (FIG. 10B). As a result, the desired reflectance is achieved easily in shorter timing (after the elapsed time of about 200 ms in this example) as compared with a case where the positive-polarity voltage is only applied. Therefore, it is possible to improve the optical reflectance by applying the reverse-polarity voltage opposite to the polarity of the display-use voltage at the time of the white display or changeover to the white display.

Further, by applying such a reverse-polarity voltage during the vertical blanking period V_{BL}, temporary transition to the black display (instantaneous drop in the optical reflectance) that is caused by the application of the reverse-polarity voltage becomes less visible as compared with a case where the reverse-polarity voltage is applied during the scan period Vscan. As a result, flickering of images as described above becomes less visible (it is unlikely that flickering of images will occur).

As described thus far, in the present embodiment, the optical reflectance of the electrophoretic display device (display body 10A) is varied in such a manner that the display-use voltage (for example, the positive-polarity voltage) is applied to the display body 10A over the period V including one or more frames, resulting in transition to the display state (for example, the white display) corresponding to the applied voltage (the positive-polarity voltage). The voltage (for example, the negative-polarity voltage or 0 V) that is different from the above-described applied voltage (the positive-polarity voltage) is applied during the one or more vertical blanking periods V_{BL} over the period of one or more frames. Consequently, in the display body 10A, the optical response property is improved, and the desired optical reflectance is achieved more easily as compared with a case where the positive-polarity voltage is only applied over one or more frame-period V. As a result, this makes it possible to achieve the desired contrast ratio and brightness. Further, in the present embodiment, the above-described reverse-polarity voltage is applied during the vertical blanking period V_{BL}, making it possible to suppress instantaneous flickering of the image that may be caused by application of the reverse-polarity voltage. This allows the display quality to be improved.

Hereinafter, the description is provided on another embodiment and modification examples of the above-described first embodiment. Hereunder, any component parts similar to those in the above-described first embodiment are denoted with the same reference numerals, and the related descriptions are omitted as appropriate.

### Second Embodiment

In the display unit and the method of driving the display unit according to the above-described first embodiment, the reverse-polarity voltage (or 0 V, the same applies hereinafter) that serves to improve the optical reflectance is applied during the vertical blanking period from the viewpoint of the visibility. In the present embodiment, the timing of applying the reverse-polarity voltage is set from the viewpoint that is different from that of the above-described first embodiment. In the present embodiment, it is possible to further improve the effects of increasing the optical reflectance to be achieved by the application of the reverse-polarity voltage. It is to be noted that a basic configuration of a display unit and a driver for achieving a method of the present embodiment (a second display unit and a second driver in the disclosure) is similar to that of the display unit 1 and the driver 2 of the above-described first embodiment. Further, a basic drive operation (operation of setting an applied voltage waveform during a write period including a plurality of frames to perform gray-scale display) is similar to that of the above-described first embodiment.

However, in the present embodiment, during a period of one or more frames, a voltage (for example, the reverse-polarity voltage or 0 V) that is different from the display-use voltage (for example, a positive-polarity voltage) may be applied once or a plurality of times on or after a point of time P_{L}1 (first point of time) at which a derivative value of the optical reflectance in the optical response property reaches a peak magnitude thereof. Specifically, the reverse-polarity voltage or 0 V as described above may be applied on or after a point of time at which a trend toward an increase in the optical reflectance is maximized in the optical response property at the time of transition to the white display. As a result, in the display body 10A, the optical response property is improved effectively, and the desired optical reflectance is achieved more easily as compared with a case where the positive-polarity voltage is only applied during the period of one or more frames. This makes it possible to achieve the effects similar to those of the above-described first embodiment.

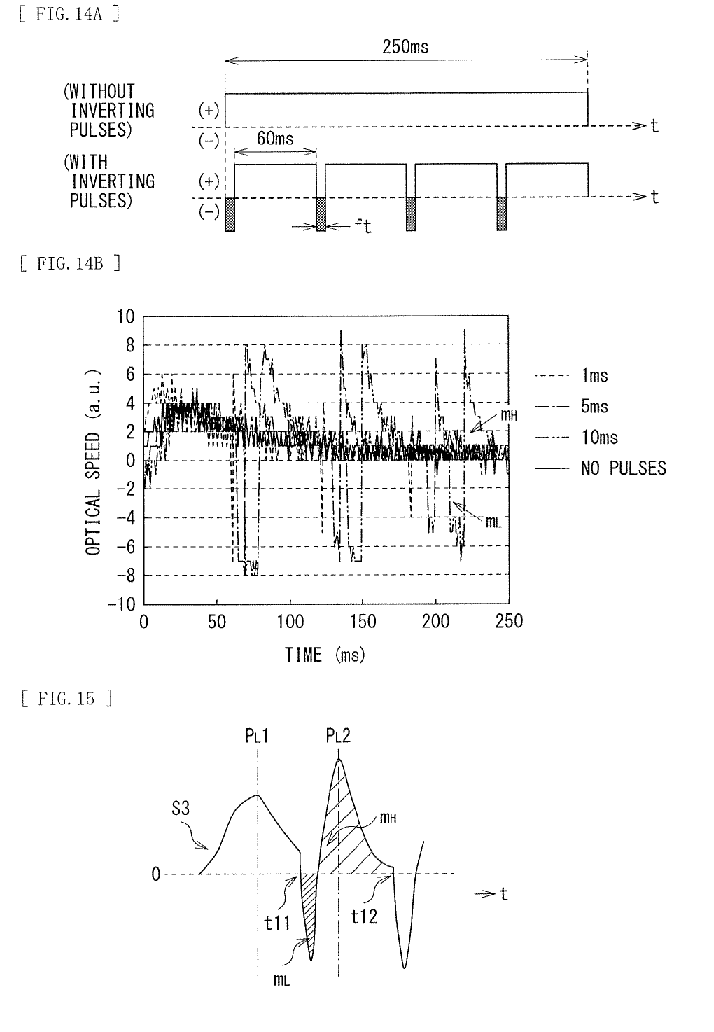

The description is provided on the above-described point of time P_{L}1 with reference to FIG. 14A, FIG. 14B, and FIG. 15. FIG. 14A is a timing chart for describing a drive operation of the display unit of the present embodiment. FIG. 14B is a characteristic diagram illustrating an example of the optical speed (a derivative value of the optical reflectance) when the reverse-polarity voltage is applied (duration of applying the voltage: 1 ms, 5 ms, and 10 ms) and when no reverse-polarity voltage is applied. In FIG. 14, when the optical speed is a positive value, the optical reflectance exhibits a trend toward an increase, which indicates that the optical reflectance at the current time is higher than that at the time immediately prior to the current time. On the contrary, when the optical speed is a negative value, the optical reflectance exhibits a trend toward a decrease, which indicates that the optical reflectance at the current time is lower than that at the time immediately prior to the current time. FIG. 15 is a pattern diagram for describing a timing sequence of applying the reverse-polarity voltage.

A chart on the top side of FIG. 14A illustrates an example of a voltage waveform when the positive-polarity voltage is applied consecutively (the reverse-polarity voltage is not applied) over a period of 250 ms, for example. Further, a chart on the bottom side of FIG. 14A illustrates an example of a voltage waveform when the reverse-polarity voltage (negative-polarity voltage) is applied discretely (a plurality of times) in the middle of application of the positive-polarity voltage. In the chart on the bottom side of FIG. 14A, the positive-polarity voltage is applied consecutively and a plurality of times over the predetermined period of 250 ms. The negative-polarity voltage is applied a plurality of times at the predetermined time ft (1 ms, 5 ms, and 10 ms) with a time interval of 60 ms.

A time duration (pulse width) ft of applying the negative-polarity voltage may be within the range of 0.1 ms to 25 ms, for example. The time ft may be set at a proper value depending on a frame frequency. For example, when the frame frequency is 100 Hz, the time ft may be within the range of 0.1 ms to 10 ms. When the frame frequency is 80 Hz, the time ft may be within the range of 0.1 ms to 12.5 ms. When the frame frequency is 65 Hz, the time ft may be within the range of 0.1 ms to 15.4 ms. When the frame frequency is 50 Hz, the time ft may be within the range of 0.1 ms to 20 ms. When the frame frequency is 40 Hz, the time ft may be within the range of 0.1 ms to 25 ms.

The timing of applying the negative-polarity voltage is not limited specifically as long as such a voltage is applied on or after the above-described point of time P_{L}1. In other words, in the present embodiment, the negative-polarity voltage may be applied during the vertical blanking period V_{BL}, or may be applied during the scan period Vscan. Alternatively, the negative-polarity voltage may be applied during both the vertical blanking period V_{BL} and the scan period Vscan.

Further, when the negative-polarity voltage is to be applied more than two times, the timing from a second time on may be preferably set on or after a point of time P_{L}2 (second point of time) at which a decrease in the optical reflectance owing to the previous application of the negative-polarity voltage is exceeded by an increase in the optical reflectance owing to subsequent application of the positive-polarity voltage. Specifically, as schematically illustrated in FIG. 15, first-time timing t11 of applying the negative-polarity voltage may be set on or after the point of time P_{L}1 at which a first maximum value is taken in an optical speed property S3 equivalent to a derivative value of the optical reflectance. Further, second-time timing t12 of applying the negative-polarity voltage may be set on or after the point of time P_{L}2 at which a decrease in the optical reflectance (equivalent to the area m_{L}) owing to first-time application of the negative-polarity voltage is exceeded by an increase in the optical reflectance (equivalent to the area m_{H}) owing to subsequent application of the positive-polarity voltage (a difference in the area (m_{H}−m_{L}) is equal to 0 or more).

### Modification Example 1

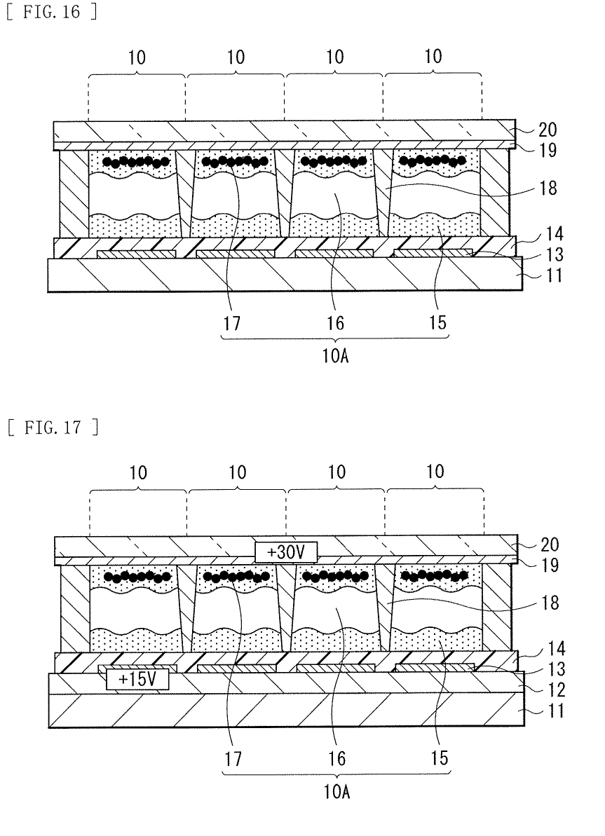

FIG. 16 illustrates a key part configuration of a display unit according to a modification example (modification example 1) of the above-described first embodiment. For the above-described first embodiment, described is a configuration example where the display drive is performed in the active-matrix drive method with use of the TFT devices. However, the display unit and the drive method of the disclosure are also applicable to any drive method that uses no TFT devices. Examples of such drive methods may include a passive-matrix drive method, a segment drive method, and any other drive method. In this case, the first electrodes 13 may be provided on the substrate 11, and those first electrodes 13 may be covered with the sealing layer 14, as illustrated in FIG. 16. On the sealing layer 14, the display body 10A, the second electrode 19, and the second substrate 20 may be disposed, as with the above-described first embodiment. Further, the display body 10A may be divided into a plurality of regions by the partition 18. The first electrodes 13 and the second electrode 19 may be electrodes that are disposed in a lattice pattern as a whole.

In the present modification example as well, a predetermined potential may be applied to each of the first electrode 13 and the second electrode 19, and a voltage corresponding to such a potential difference may be applied to the display body 10A. As a result, in the display body 10A, the optical reflectance may vary in a time-series manner depending on the applied voltage, leading to the white display, black display, and gray-scale display being carried out. At this time, by applying the voltage that is different from the display-use voltage in the predetermined timing (in the timing described in the above-described first embodiment and second embodiment) over the period of one or more frames, the optical response property of the display body 10A is improved, thereby achieving the desired optical reflectance, as with the above-described first embodiment. Consequently, it is possible to obtain effects substantially equivalent to those of the above-described first embodiment or second embodiment.

### Modification Example 2

FIG. 17 illustrates a key part configuration of a display unit according to a modification example (modification example 2) of the above-described first embodiment. For the above-described first embodiment, described is the drive of varying a potential of the first electrode 13 (applying a pulse voltage to the first electrode 13) at the time of applying a voltage (second voltage) that is different from the display-use voltage (first voltage) to the display body 10A. However, the drive method of the disclosure for applying the second voltage is not limited thereto. As with the present modification example, for example, a potential of the second electrode 19 may be varied alternatively.

Specifically, in the timing of applying the reverse-polarity voltage (or 0 V) as described above to the display body 10A, a potential of the second electrode 19 may be varied from 0 V to a predetermined potential, for example. As an example, the following drive may be performed in applying the reverse-polarity voltage during a frame period when the positive-polarity voltage of +15 V is applied as the display-use voltage (for example, a potential of the first electrode 13 is +15 V, and a potential of the second electrode 19 is 0 V). In other words, the first electrode 13 is held at a potential of +15 V, while varying a potential of the second electrode 19 from 0 V to +30 V. As a result, the negative-polarity voltage of −15 V may be applied to the display body 10A (a potential difference between the first electrode 13 and the second electrode 19 may become −15 V). Thereafter, by returning the potential of the second electrode 19 back to 0 V, it is possible to achieve the effects of an increase in the optical reflectance with use of the reverse-polarity voltage, as with the above-described first embodiment or second embodiment. It is to be noted that the timing and the time duration (pulse width) of applying the reverse-polarity voltage may be similar to those in the above-described first embodiment or second embodiment.

### Application Example

Next, the description is provided on an application example of any of the display units mentioned in the above-described embodiments and modification example thereof. However, a configuration of an electronic apparatus to be hereinafter described is merely exemplified, and the configuration may be changed as appropriate.

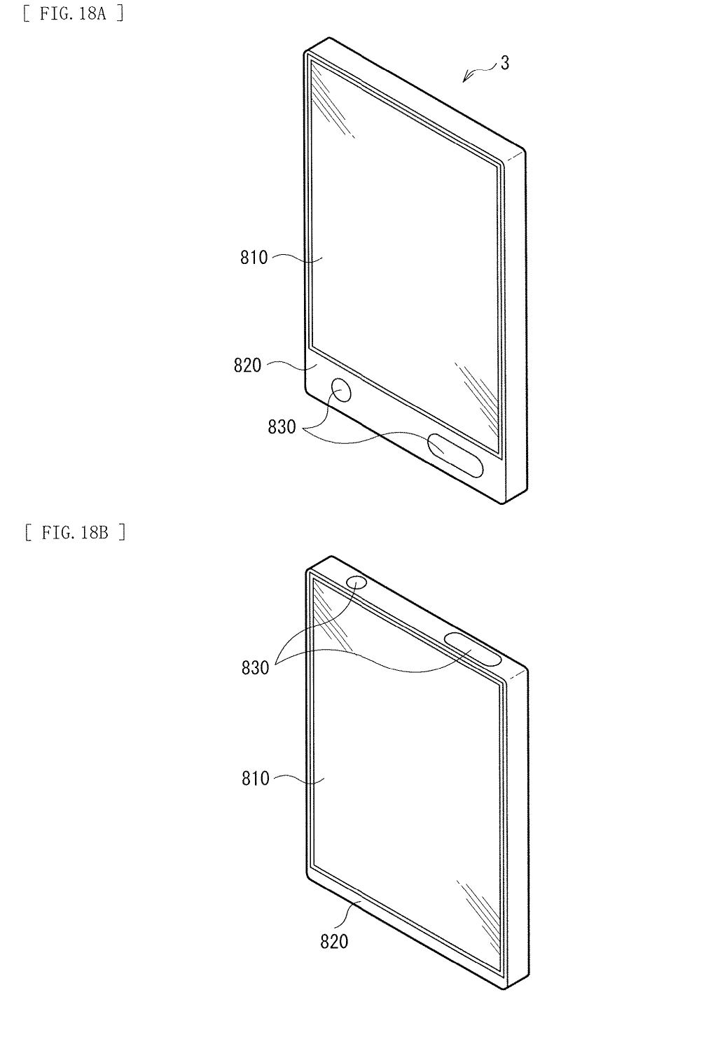

Each of FIGS. 18A and 18B illustrates an external appearance configuration of an electronic book (electronic book 3) according to an application example. The electronic book 3 may include, for example, a display section 810 and a non-display section (housing) 820, as well as an operating section 830. It is to be noted that the operating section 830 may be provided at the front of the non-display section 820 as illustrated in FIG. 18A, or may be provided on the top surface as illustrated in FIG. 18B.

The disclosure is described thus far with reference to the embodiments; however, the disclosure is not limited to what has been described in the embodiments, but various modifications may be made. For example, in the above-described embodiments, the description is provided taking as an example where the reverse-polarity voltage that is different from the first voltage in polarity or 0 V is applied as the second voltage of the disclosure. However, the second voltage may not be necessarily the reverse-polarity voltage, and may be any voltage that is different from the first voltage. For example, the second voltage may be 0 V. Alternatively, when the first voltage is a positive-polarity voltage for transition from the black display to the white display, the second voltage may be a voltage with a magnitude of less than the first voltage. However, it is possible to improve the reflectance efficiently by applying the reverse-polarity voltage as the second voltage, as with the above-described embodiments. It is to be noted that the effects described herein are merely exemplified and non-limiting, and effects of the disclosure may be other effects, or may further include other effects.

It is to be noted that the disclosure may be configured as follows.

(1)

A display unit including:

an electrophoretic display device in which an optical reflectance varies on a time-series basis depending on an applied voltage; and

a drive circuit that performs voltage drive of the electrophoretic display device, the drive circuit applying a first voltage to the electrophoretic display device over a period of one or more frames, applying a second voltage during one or more vertical blanking periods in the period of one or more frames, the first voltage being directed to display, the second voltage being different from the first voltage.

(2)

The display unit according to (1), wherein

the first voltage includes a voltage of a first polarity that allows the electrophoretic display device to make a transition from a black display state to a white display state, and

the second voltage includes a voltage of a second polarity that is reverse to the first polarity.

(3)

The display unit according to (1), wherein

the first voltage includes a voltage of a first polarity that allows the electrophoretic display device to make a transition from a black display state to a white display state, and

the second voltage includes a voltage that is 0 V or less than the first voltage.

(4)

The display unit according to any one of (1) to (3), wherein a voltage of same polarity as the first voltage or a voltage of same potential as the first voltage is applied after the second voltage is applied during the one or more vertical blanking periods.

(5)

The display unit according to any one of (1) to (4), further including a plurality of pixels each including the electrophoretic display device and each of which is driven by a TFT device, wherein

the second voltage is applied to the plurality of pixels together by turning on the TFT devices in the plurality of pixels together during the one or more vertical blanking periods.

(6)

The display unit according to any one of (1) to (5), wherein the electrophoretic display device includes an insulating liquid, a fibrous structure, and electrophoretic particles between a first electrode and a second electrode.

(7)

A display unit including:

an electrophoretic display device in which an optical reflectance varies on a time-series basis depending on an applied voltage; and

a drive circuit that performs voltage drive of the electrophoretic display device, the drive circuit applying a first voltage to the electrophoretic display device over a period of one or more frames, applying, in the period of one or more frames, a second voltage on or after a first point of time at which a derivative value of the optical reflectance reaches a maximum magnitude, the first voltage being directed to display, the second voltage being different from the first voltage.

(8)

The display unit according to (7), wherein

the first voltage includes a voltage of a first polarity that allows the electrophoretic display device to make a transition from a black display state to a white display state, and

the second voltage includes a voltage of a second polarity that is reverse to the first polarity.

(9)

The display unit according to (7) or (8), wherein, when the second voltage is to be applied a plurality of times,

a timing at which the second voltage is applied for first time is set on or after the first point of time, and

a timing at which the second voltage is applied for second time and after is set on or after a second point of time, the second point of time being a point of time at which a decrease in the optical reflectance owing to a previous application of the second voltage is exceeded by an increase in the optical reflectance owing to an application of the first voltage subsequent to the previous application of the second voltage.

(10)

The display unit according to any one of (7) to (9), wherein a time duration in which the second voltage is applied is within a range from 0.1 milliseconds to 25 milliseconds.

(11)

A drive method including:

applying a first voltage to an electrophoretic display device over a period of one or more frames to vary an optical reflectance of the electrophoretic display device on a time-series basis, the first voltage being directed to display; and

applying, upon varying the optical reflectance of the electrophoretic display device on the time-series basis, a second voltage during one or more vertical blanking periods in the period of one or more frames, the second voltage being different from the first voltage.

(12)

The drive method according to (11), wherein

the first voltage includes a voltage of a first polarity that allows the electrophoretic display device to make a transition from a black display state to a white display state, and

the second voltage includes a voltage of a second polarity that is reverse to the first polarity.

(13)

The drive method according to (11), wherein

the first voltage includes a voltage of a first polarity that allows the electrophoretic display device to make a transition from a black display state to a white display state, and

the second voltage includes a voltage that is 0 V or less than the first voltage.

(14)

The drive method according to any one of (11) to (13), wherein a voltage of same polarity as the first voltage or a voltage of same potential as the first voltage is applied after the second voltage is applied during the one or more vertical blanking periods.

(15)

The drive method according to any one of (11) to (14), wherein

the electrophoretic display device includes a plurality of pixels each of which is driven by a TFT device, and

the second voltage is applied to the plurality of pixels together by turning on the TFT devices in the plurality of pixels together during the one or more vertical blanking periods.

(16)

A drive method including:

applying a first voltage to an electrophoretic display device over a period of one or more frames to vary an optical reflectance of the electrophoretic display device on a time-series basis, the first voltage being directed to display; and

applying, upon varying the optical reflectance of the electrophoretic display device on the time-series basis and in the period of one or more frames, a second voltage on or after a first point of time at which a derivative value of the optical reflectance reaches a maximum magnitude, the second voltage being different from the first voltage.

(17)

The drive method according to (16), wherein

the first voltage includes a voltage of a first polarity that allows the electrophoretic display device to make a transition from a black display state to a white display state, and

the second voltage includes a voltage of a second polarity that is reverse to the first polarity.

(18)

The drive method according to (16) or (17), when the second voltage is to be applied a plurality of times,

a timing at which the second voltage is applied for first time is set on or after the first point of time, and

a timing at which the second voltage is applied for second time and after is set on or after a second point of time, the second point of time being a point of time at which a decrease in the optical reflectance owing to a previous application of the second voltage is exceeded by an increase in the optical reflectance owing to an application of the first voltage subsequent to the previous application of the second voltage.

(19)

The drive method according to any one of (16) to (18), wherein a time duration in which the second voltage is applied is within a range from 0.1 milliseconds to 25 milliseconds.

(20)

An electronic apparatus with a display unit, the display unit including:

an electrophoretic display device in which an optical reflectance varies on a time-series basis depending on an applied voltage; and

a drive circuit that performs voltage drive of the electrophoretic display device, the drive circuit applying a first voltage to the electrophoretic display device over a period of one or more frames, applying a second voltage during one or more vertical blanking periods in the period of one or more frames, the first voltage being directed to display, and the second voltage being different from the first voltage.

This application claims the benefit of Japanese Priority Patent Application No. 2014-243163 filed on Dec. 1, 2014 with Japan Patent Office, the entire contents of which are incorporated in this application by reference.

Those skilled in the art could assume various modifications, combinations, subcombinations, and changes in accordance with design requirements and other contributing factors. However, it is understood that they are included within a scope of the attached claims or the equivalents thereof.

1. A display unit comprising:
an electrophoretic display device in which an optical reflectance varies on a time-series basis depending on an applied voltage; and
a drive circuit that performs voltage drive of the electrophoretic display device, the drive circuit applying a first voltage to the electrophoretic display device over a period of one or more frames, applying a second voltage during one or more vertical blanking periods in the period of one or more frames, the first voltage being directed to display, the second voltage being different from the first voltage.

2. The display unit according to claim 1, wherein
the first voltage comprises a voltage of a first polarity that allows the electrophoretic display device to make a transition from a black display state to a white display state, and
the second voltage comprises a voltage of a second polarity that is reverse to the first polarity.

3. The display unit according to claim 1, wherein
the first voltage comprises a voltage of a first polarity that allows the electrophoretic display device to make a transition from a black display state to a white display state, and
the second voltage comprises a voltage that is 0 V or less than the first voltage.

4. The display unit according to claim 1, wherein a voltage of same polarity as the first voltage or a voltage of same potential as the first voltage is applied after the second voltage is applied during the one or more vertical blanking periods.

5. The display unit according to claim 1, further comprising a plurality of pixels each including the electrophoretic display device and each of which is driven by a TFT device, wherein
the second voltage is applied to the plurality of pixels together by turning on the TFT devices in the plurality of pixels together during the one or more vertical blanking periods.

6. The display unit according to claim 1, wherein the electrophoretic display device includes an insulating liquid, a fibrous structure, and electrophoretic particles between a first electrode and a second electrode.

7. A display unit comprising:
an electrophoretic display device in which an optical reflectance varies on a time-series basis depending on an applied voltage; and
a drive circuit that performs voltage drive of the electrophoretic display device, the drive circuit applying a first voltage to the electrophoretic display device over a period of one or more frames, applying, in the period of one or more frames, a second voltage on or after a first point of time at which a derivative value of the optical reflectance reaches a maximum magnitude, the first voltage being directed to display, the second voltage being different from the first voltage.

8. The display unit according to claim 7, wherein
the first voltage comprises a voltage of a first polarity that allows the electrophoretic display device to make a transition from a black display state to a white display state, and
the second voltage comprises a voltage of a second polarity that is reverse to the first polarity.

9. The display unit according to claim 7, wherein, when the second voltage is to be applied a plurality of times,
a timing at which the second voltage is applied for first time is set on or after the first point of time, and
a timing at which the second voltage is applied for second time and after is set on or after a second point of time, the second point of time being a point of time at which a decrease in the optical reflectance owing to a previous application of the second voltage is exceeded by an increase in the optical reflectance owing to an application of the first voltage subsequent to the previous application of the second voltage.

10. The display unit according to claim 7, wherein a time duration in which the second voltage is applied is within a range from 0.1 milliseconds to 25 milliseconds.

11. A drive method comprising:
applying a first voltage to an electrophoretic display device over a period of one or more frames to vary an optical reflectance of the electrophoretic display device on a time-series basis, the first voltage being directed to display; and
applying, upon varying the optical reflectance of the electrophoretic display device on the time-series basis, a second voltage during one or more vertical blanking periods in the period of one or more frames, the second voltage being different from the first voltage.

12. The drive method according to claim 11, wherein
the first voltage comprises a voltage of a first polarity that allows the electrophoretic display device to make a transition from a black display state to a white display state, and
the second voltage comprises a voltage of a second polarity that is reverse to the first polarity.

13. The drive method according to claim 11, wherein
the first voltage comprises a voltage of a first polarity that allows the electrophoretic display device to make a transition from a black display state to a white display state, and
the second voltage comprises a voltage that is 0 V or less than the first voltage.

14. The drive method according to claim 11, wherein a voltage of same polarity as the first voltage or a voltage of same potential as the first voltage is applied after the second voltage is applied during the one or more vertical blanking periods.

15. The drive method according to claim 11, wherein
the electrophoretic display device includes a plurality of pixels each of which is driven by a TFT device, and
the second voltage is applied to the plurality of pixels together by turning on the TFT devices in the plurality of pixels together during the one or more vertical blanking periods.

16. A drive method comprising:
applying a first voltage to an electrophoretic display device over a period of one or more frames to vary an optical reflectance of the electrophoretic display device on a time-series basis, the first voltage being directed to display; and
applying, upon varying the optical reflectance of the electrophoretic display device on the time-series basis and in the period of one or more frames, a second voltage on or after a first point of time at which a derivative value of the optical reflectance reaches a maximum magnitude, the second voltage being different from the first voltage.

17. The drive method according to claim 16, wherein
the first voltage comprises a voltage of a first polarity that allows the electrophoretic display device to make a transition from a black display state to a white display state, and
the second voltage comprises a voltage of a second polarity that is reverse to the first polarity.

18. The drive method according to claim 16, when the second voltage is to be applied a plurality of times,
a timing at which the second voltage is applied for first time is set on or after the first point of time, and
a timing at which the second voltage is applied for second time and after is set on or after a second point of time, the second point of time being a point of time at which a decrease in the optical reflectance owing to a previous application of the second voltage is exceeded by an increase in the optical reflectance owing to an application of the first voltage subsequent to the previous application of the second voltage.

19. The drive method according to claim 16, wherein a time duration in which the second voltage is applied is within a range from 0.1 milliseconds to 25 milliseconds.

20. An electronic apparatus with a display unit, the display unit comprising:
an electrophoretic display device in which an optical reflectance varies on a time-series basis depending on an applied voltage; and
a drive circuit that performs voltage drive of the electrophoretic display device, the drive circuit applying a first voltage to the electrophoretic display device over a period of one or more frames, applying a second voltage during one or more vertical blanking periods in the period of one or more frames, the first voltage being directed to display, and the second voltage being different from the first voltage.
